(19) United States
(12) Patent Application Publication
(10) Pub. No.: US 2013/0303022 A1
(43) Pub. Date: Nov. 14, 2013

(54) CABLE ASSEMBLY WITH CONNECTOR

(71) Applicants: HONG FU JIN PRECISION INDUSTRY (WuHan) CO., LTD., (US); HON HAI PRECISION INDUSTRY CO., LTD., New Taipei (TW)

(72) Inventors: XIAO-LIN ZHANG, Wuhan (CN); MING-HUI LUO, Wuhan (CN); HUI-MIN ZHOU, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/718,475

(22) Filed: Dec. 18, 2012

(30) Foreign Application Priority Data
May 9, 2012 (CN) 201210141626.5

(51) Int. Cl. H01R 13/6592

(52) U.S. Cl. CPC H01R 13/6592
USPC 439/607.44

(57) ABSTRACT

A cable assembly includes two connectors and a cable module. Each connector is configured for connecting to a corresponding connector of an electronic device. The cable module include a first grounding wire, a power wire, a data receiving wire, and a data sending wire. A first grounding wire end forks to form two third grounding wires. A power wire end forks to form two second power wires. A data receiving wire end forks to form two second data receiving wires. A data sending wire end forks to form two second data wires. The third grounding wires, the second power wires, the second data receiving wires, and the second data sending wires compose a group of connecting cables. The groups of connecting cables are respectively connected to the connectors.

### BACKGROUND

1. Technical Field

The present disclosure relates to cable assemblies, more particularly to a cable assembly with a USB 2.0 connector.

2. Description of Related Art

Generally, a computer or a server comprises a number of connectors, such as a USB connector and an audio jack, for connecting peripheral devices. To connect the peripheral devices, each peripheral device needs a group of cables to connect to a corresponding connector. Each group of cables is surrounded by a jacket. Groups of cables of the peripheral devices are difficult to arrange, and it is a waste of jacket material.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of a cable assembly in accordance with an embodiment.

FIG. 2 is an assembled, isometric view of the cable assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

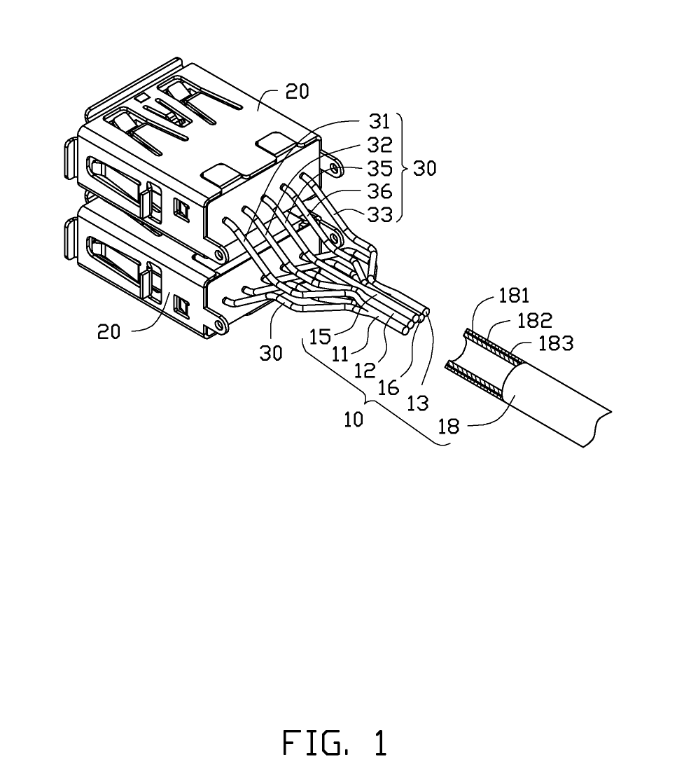

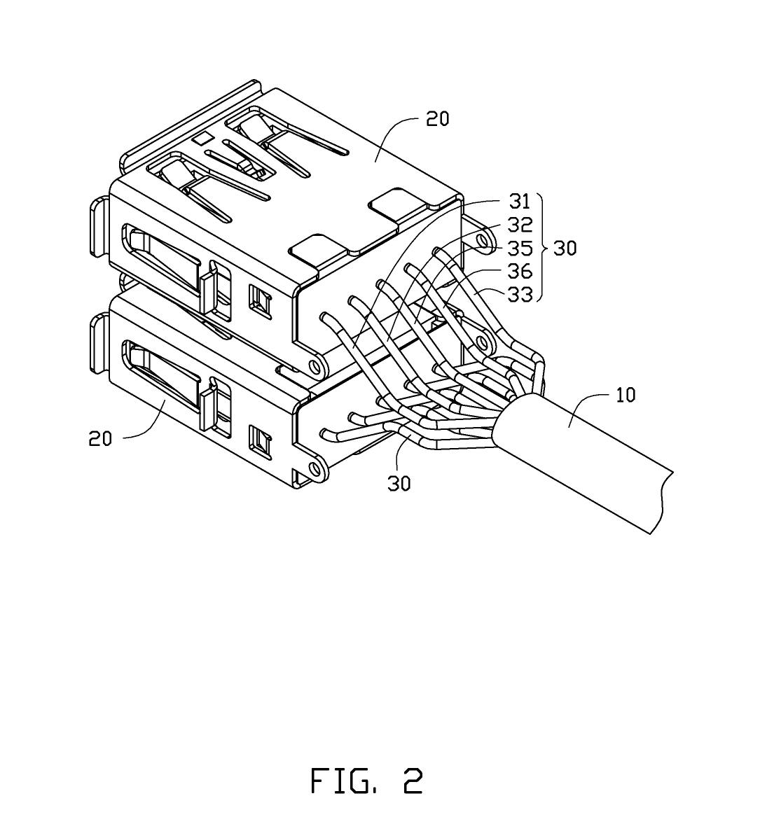

FIG. 1 and FIG. 2 illustrate a cable assembly of an embodiment. The cable assembly comprises a cable module 10 and two connectors 20.

The cable module 10 comprises a first grounding wire 11, a second grounding wire 12, a power wire 13, a data receiving wire 15, a data sending wire 16, and a jacket 18.

The jacket 18 is used for wrapping the first grounding wire 11, the second grounding wire 12, the power wire 13, the data receiving wire 15, and the data sending wire 16. Each of the data receiving wire 15 and the data sending wire 16 defines a plurality of data channels. The jacket 18 comprises an inner layer 181, a woven layer 182, and an outer layer 183. The woven layer 182 is located between the inner layer 181 and the outer layer 183. The first grounding wire 11 is electronically connected to the inner layer 181 by soldering. In one embodiment, the inner layer 181 is an aluminum foil layer.

Each of two opposite ends of each of the first grounding wire 11, the second grounding wire 12, the power wire 13, the data receiving wire 15, and the data sending wire 16 forks to form four groups of connecting cables 30. In the figures only two of groups of connecting cables 30 are shown to simplify explanation. Each group of connecting cables 30 shown, adapted to connect to one of the two connectors 20, comprises a third grounding wire 31, a fourth grounding wire 32, a second power wire 33, a second data receiving wire 35, and a second data sending wire 36.

Each of two connectors 20 is used to connect to a corresponding connector in an electronic device. In one embodiment, each of the two connectors 20 is a USB 2.0 connector, and the electronic device is a computer or a server.

In assembly, the third grounding wires 31 and the fourth grounding wires 32 are for connecting to ground. The second power wires 33 are for connecting to a power supply (not shown). The second data receiving wires 35 occupy two different data channels of the data receiving wire 15. The second data sending wires 36 occupy two different data channels of the data sending wire 16.

A first end of the cable module 10 connects to the connectors 20. A second end of the cable module 10 (not shown) connects to two other connectors (not shown), and the two other connectors connect to two peripheral devices.

In use, data between the two peripheral devices and the electronic device is transferred by the two connectors 20 and the two other connectors via the cable module 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A cable assembly comprising:
two connectors, and each of the two connectors is configured for connecting a corresponding connector of an electronic device; and
a cable module comprising a first grounding wire, a power wire, a data receiving wire, and a data sending wire;
wherein a first grounding wire end is forked to form two third grounding wires; a power wire end is forked to form two second power wires; a data receiving wire end is forked to form two second data receiving wires; a data sending wire end is forked to form two second data sending wires; and each of the two third grounding wires, the two second power wires, the two second data receiving wires, and the two second data sending wires compose a group of connecting cables; and the group of connecting cables is connected to one of the two connectors.

2. The cable assembly of claim 1, wherein the cable module further comprises a jacket and a second grounding wire, the jacket wraps the first grounding wire, the second grounding wire, the power wire, the data receiving wire, and the data sending wire.

3. The cable assembly of claim 2, wherein a second grounding wire end is forked to form two fourth grounding wires, and each group of connecting cables further comprises one of the two fourth grounding wires.

4. The cable assembly of claim 2, wherein the jacket comprises an inner layer, a woven layer, and an outer layer, and the woven layer is located between the inner layer and the outer layer; and the first grounding wire is welded to the inner layer.

5. The cable assembly of claim 4, wherein the first grounding wire is grounded.

6. The cable assembly of claim 4, wherein the inner layer is an aluminum foil layer.

7. The cable assembly of claim 1, wherein each of the two connectors is a USB 2.0 connector.

8. A cable assembly comprising:
two connectors, and each of the two connectors is configured for connecting a corresponding connector of an electronic device; and
a cable module comprising a jacket, a first grounding wire, a power wire, a data receiving wire, and a data sending wire; and the jacket wrapping the first grounding wire, the power wire, the data receiving wire, and the data sending wire;
wherein a first grounding wire end is forked to form two third grounding wires; a power wire end is forked to form two second power wires; a data receiving wire end is forked to form two second data receiving wires; a data sending wire end is forked to form two second data second wires; each of the two third grounding wires, the two second power wires, the two second data receiving wires and the two second data sending wires compose a group of connecting cables; and the group of connecting cables is connected to one of the two connectors.

9. The cable assembly of claim 8, wherein the cable module further comprises a second grounding wire, the jacket further wraps the second grounding wire.

10. The cable assembly of claim 9, wherein a second grounding wire end is forked to form two fourth grounding wires, and each group of connecting cables further comprises one of the two fourth grounding wires.

11. The cable assembly of claim 8, wherein the jacket comprises an inner layer, a woven layer, and an outer layer, and the woven layer is located between the inner layer and the outer layer; and the first grounding wire is welded to the inner layer.

12. The cable assembly of claim 11, wherein the first grounding wire is grounded.

13. The cable assembly of claim 11, wherein the inner layer is an aluminum foil layer.

14. The cable assembly of claim 8, wherein each of the two connectors is a USB 2.0 connector.
